(19) United States
(12) Patent Application Publication
(10) Pub. No.: US 2025/0234095 A1
(43) Pub. Date: Jul. 17, 2025

(54) EXPOSURE CONTROL DEVICE AND EXPOSURE CONTROL METHOD FOR VEHICLE ON-BOARD CAMERA

(71) Applicant: DENSO CORPORATION, Kariya-city (JP)

(72) Inventors: Masato NISHIKAWA, Kariya-city (JP); Toshikazu MURAO, Kariya-city (JP)

(21) Appl. No.: 19/022,403

(22) Filed: Jan. 15, 2025

(30) Foreign Application Priority Data
Jan. 17, 2024 (JP) 2024-005334

(51) Int. Cl. H04N 23/73; H04N 7/18; H04N 23/71

(52) U.S. Cl. CPC H04N 23/73; H04N 7/188; H04N 23/71

(57) ABSTRACT

An exposure control device is configured to control an exposure of a camera mounted to a host vehicle. The exposure control device includes an event information acquisition unit configured to acquire detected information of an event for the host vehicle, and an exposure control unit configured to set an exposure condition based on the detected information acquired by the event information acquisition unit.

### CROSS-REFERENCE TO RELATED APPLICATION

This application is based on and claims the benefit of priority from earlier Japanese Patent Application No. 2024-005334 filed Jan. 17, 2024, the description of which is incorporated herein by reference.

### BACKGROUND

### Technical Field

This disclosure relates to an exposure control device and an exposure control method for controlling the exposure of a camera mounted to a vehicle.

### Related Art

A known drive recorder includes a camera, an encoder, a memory drive, and a recording controller. The camera captures images of surroundings of a vehicle at a first frame rate or a second frame rate. The encoder encodes and multiplexes image data, date and time data, and voice data. The memory drive records the multiplexed data in a recording medium. The recording controller records the multiplexed data at the first frame rate when an ignition switch is detected as being on, and records the multiplexed data at the second frame rate when the ignition switch is detected as being off. In response to an impact on the vehicle exceeding a predefined value in a situation where the ignition switch is off and the image data and other data are being recorded at the second frame rate, the frame rate is switched from the second frame rate to the first frame rate, and the image data and other data are recorded at the first frame rate for a predefined period of time. More specifically, for example, while the image data is being recorded at a frame rate of 1 fps, a determination is made as to whether the impact (e.g. a physical quantity such as acceleration) detected by a shock sensor has exceeded a pre-set threshold value. This determination is made on the assumption of occurrence of an impact in the event that someone forcibly opens a vehicle door or breaks a windowpane for the purpose of mischief or the like. In response to the impact detected by the shock sensor exceeding the threshold value, a timer for about 5-10 minutes, for example, is started. The image data and other data are recorded at a frame rate of 27.5 fps until expiration of the timer. Upon the expiration of the timer, the frame rate is returned to 1 fps.

### BRIEF DESCRIPTION OF THE DRAWINGS

In the accompanying drawings:

FIG. 1 is a schematic block diagram of a system equipped with an exposure control device according to one embodiment of the present disclosure;

FIG. 2 is a schematic functional block diagram of the exposure control device depicted in FIG. 1; and

FIG. 3 is a schematic flowchart of operations of the exposure control device depicted in FIG. 2.

### DESCRIPTION OF SPECIFIC EMBODIMENTS

For example, there is a demand to operate the drive recorder in a situation where the vehicle power source is off at night, as a countermeasure against theft from vehicle, hit-and-run, etc. In such a situation, the brightness of the field of vision is assumed to be very low as compared to a situation where the vehicle power source is on, such as during travel of the vehicle, because vehicle's headlights and other lights are off. Where the subject is another vehicle, the lights of that vehicle may be on. In contrast, where the subject is a person, that person may not usually wear any light-emitting device that illuminates his or her face. Thus, when exposure control is performed assuming that the subject is a person, an issue may arise where the image of the license plate of the other vehicle becomes so saturated that it can not be read. In this regard, the above known technique, as disclosed in JP2017-102918A, is effective in preventing frame dropping of the subject (i.e., discontinuity in the reproduced images). However there remains an issue that the above known technique fails to capture images with appropriate exposure control according to the subject. That is, there remains an issue of saturation or shadow clipping depending on the subject.

In view of the foregoing, it is desired to have a technique for enabling an imaging device mounted to a vehicle to capture good images of any subject in a low-illuminance environment, such as at night.

One aspect of the present disclosure provides an exposure control device for controlling an exposure of a camera mounted to a host vehicle. The exposure control device includes an event information acquisition unit configured to acquire detected information of an event for the host vehicle, and an exposure control unit configured to set an exposure condition based on the detected information acquired by the event information acquisition unit.

Another aspect of the present disclosure provides an exposure control method for controlling an exposure of a camera mounted to a host vehicle. The exposure control method includes acquiring detected information of an event for the host vehicle, and setting an exposure condition based on the detected information acquired.

Still another aspect of the present disclosure provides a computer program product for controlling an exposure of a camera mounted to a host vehicle. The computer program product is embodied in a non-transitory computer readable storage medium and includes computer instructions for acquiring detected information of an event for the host vehicle, and computer instructions for setting an exposure condition based on the detected information acquired.

### EMBODIMENTS

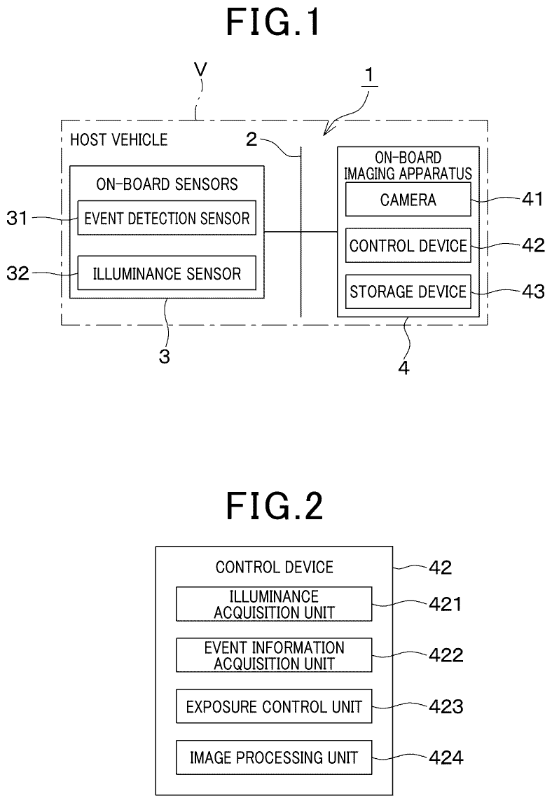

Exemplary embodiments and their specific examples of the present disclosure will now be described with reference to the accompanying drawings. Referring to FIG. 1, a host vehicle Vis a vehicle equipped with a system 1 according to one embodiment of the present disclosure. The system 1 includes an on-board network 2, on-board sensors 3, and an on-board imaging apparatus 4.

The on-board network 2 is configured to comply with a specific communication standard, such as CAN (international registered trademark: international registration number 1048262A). CAN is an abbreviation for Controller Area Network. In addition to a main network compliant with the CAN, the on-board network 2 may also include sub-networks compliant with LIN, FlexRay, etc. LIN is an abbreviation for Local Interconnect Network.

The on-board sensors 3 are connected to the on-board network 2 so as to detect a traveling state and environment of the host vehicle V and then output information or signals corresponding to the detected traveling state and environment to the on-board network 2. That is, the on-board sensors 3 include various types of sensors used to control the operations of the host vehicle V, such as a speed sensor, a yaw-rate sensor, a raindrop sensor, and other sensors. In the present embodiment, the host vehicle V has at least an event detection sensor 31 and an illuminance sensor 32 mounted to the vehicle as the on-board sensors 3. The event detection sensor 31 is an impact sensor, such as an acceleration sensor, and is capable of detecting events for the host vehicle V. The term “events” refer to impact events due to application of external forces to the host vehicle V, including, for example, a contact or collision with a person or another vehicle. The illuminance sensor 32 is configured to generate an output corresponding to the illuminance, that is, the brightness, of the surroundings of the host vehicle V.

The on-board imaging apparatus 4 includes a camera 41, a control device 42, and a storage device 43. The camera 41 is a so-called digital camera device, and includes an image sensor such as a CCD or CMOS. CCD is an abbreviation for Charge Coupled Device. CMOS is an abbreviation for Complementary Metal Oxide Semiconductor. The camera 41 is mounted to the host vehicle V and is configured to capture images of at least the surroundings of the host vehicle V. Specifically, the camera 41 is installed at a predefined front side position in the cabin of the host vehicle V so as to capture at least images in the forward direction of the host vehicle V through the windshield. The control device 42 as an exposure control device of this disclosure is configured to control the exposure of the camera 41. Details of the configuration of the control device 42 will be described later. The storage device 43 includes a non-transitory tangible storage medium, such as a flash memory, and is configured to record images captured by the camera 41 in chronological order for a predefined period of time. In the present embodiment, the on-board imaging apparatus 4 is a so-called drive recorder, and is configured to record the images captured by the camera 41 in the storage device 43 according to detected information of events for the host vehicle V from the on-board sensors 3.

In the present embodiment, the control device 42 is configured as an on-board microcomputer, that is, an ECU, mounted to the host vehicle V. ECU is an abbreviation for Electronic Control Unit. That is, the control device 42 includes a processor including a central processing unit (CPU) or micro processing unit (MPU), and a storage medium communicatively connected to the processor, and is configured to implement predefined functions by loading and executing a computer program from the storage medium. The storage medium includes at least a read-only memory (ROM) or non-volatile rewritable memory among various non-transitory tangible storage media including the ROM and the non-volatile rewritable memory. The non-volatile rewritable memory, such as flash memory, is capable of rewriting information while the power source is on and holding the information unwritable while the power source is off. The storage medium stores, along with the computer program described above, various data such as initial values, maps, and lookup tables that are necessary to execute the computer program.

As illustrated in FIG. 2, the control device 42 includes an illuminance acquisition unit 421, an event information acquisition unit 422, an exposure control unit 423 and an image processing unit 424, as functional blocks implemented by the on-board microcomputer executing a computer program. An overview of these functional blocks will now be described.

The illuminance acquisition unit 421 is configured to acquire, from the illuminance sensor 32, results of detection of the illuminance by the illuminance sensor 32. The event information acquisition unit 422 is configured to acquire, from the event detection sensor 31, detected information of events by the event detection sensor 31. Specifically, the event information acquisition unit 422 acquires, as the detected information, information corresponding to an impact value, which is the magnitude of an impact on the host vehicle V.

The exposure control unit 423 is used to set an exposure condition of the camera 41. The “exposure condition” includes a shutter speed, an aperture value and the like, and may also be referred to as an “exposure control item”. In the present embodiment, the exposure control unit 423 sets, based on the detected information of the event from the event information acquisition unit 422, the exposure condition when the host vehicle V is parked in a low-illuminance environment such as at night or in an indoor parking area with few lighting devices. Specifically, the exposure control unit 423 sets the exposure condition for the second-type event to be more suitable for a high illuminance than the exposure condition for the first-type event, where the impact value in the second-type event is greater than the impact value in the first-type event. The first-type event is application of an impact to the host vehicle V by a person. The second type event is application of an impact to the host vehicle V by another vehicle that is different from the host vehicle V. The image processing unit 424 applies various image processing, such as contrast correction, to captured image signals from the camera 41 to generate image signals to be recorded in the storage device 43.

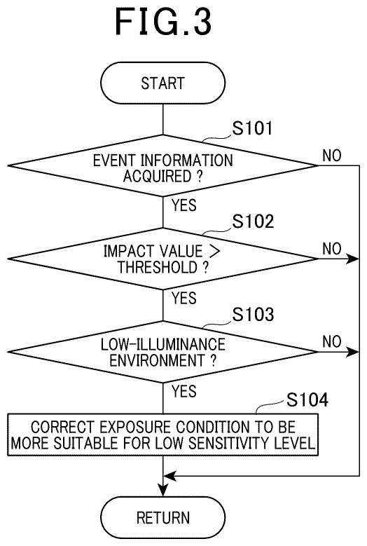

In the following, with reference to FIGS. 1 to 3, an overview of the operations of the control device 42 according to the present embodiment will be described, together with the effects exhibited by the control device 42 and the exposure control method performed by the control device 42. In the flowchart illustrated in FIG. 3, “S” is an abbreviation for “step”.

FIG. 3 illustrates a flowchart of an exposure control routine of the on-board imaging apparatus 4 when the host vehicle Vis parked. At step 101, the control device 42 determines whether the event information acquisition unit 422 has acquired detected information of an event. The detected information of an event indicates that an event has been detected by the event detection sensor 31. If the event information acquisition unit 422 has acquired detected information of an event (“YES” branch at step 101), the control device 42 proceeds to step 102. On the other hand, if the event information acquisition unit 422 has not acquired detected information of an event (“NO” branch at step 101), the control device 42 skips step 102 and steps subsequent thereto and ends this routine.

At step 102, the control device 42 determines whether the detected impact value for the current event exceeds a predefined threshold value. If the detected impact value for the current event exceeds the predefined threshold (“YES” branch at step 102), the control device 42 proceeds to step 103. On the other hand, if the detected impact value for the current event does not exceed the predefined threshold (“NO” branch at step 102), the control device 42 skips step 103 and steps subsequent thereto and ends this routine.

At step 103, the control device 42 determines whether the current environment in which the host vehicle Vis parked is a low-illuminance environment, based on the output of the illuminance sensor 32. If the current environment in which the host vehicle V is parked is a low-illuminance environment (“YES” branch at step 103), the control device 42 performs the process step 104 and then ends this routine. At step 104, the control device 42 corrects the exposure condition to be more suitable for a low sensitivity level, i.e. a high illuminance. On the other hand, if the current environment in which the host vehicle V is parked is not a low-illuminance environment (“NO” branch at step 103), the control device 42 skips step 104 and steps subsequent thereto and ends this routine.

For example, there is a demand to operate the on-board imaging apparatus 4, which is a drive recorder, in a situation where the power source of the parked host vehicle V is off (that is, the ignition switch is off) at night or in a dark place, as a countermeasure against theft from vehicle, hit-and-run, etc. In such a situation, the brightness of the field of vision of the camera 41 is assumed to be very low as compared to a situation where the power source of the host vehicle Vis on (that is, the ignition switch is on), because vehicle's headlights and other lights are off. Where the subject is another vehicle, the lights of that vehicle may be on. In contrast, where the subject is a person, that person may not usually wear any light-emitting device that illuminates his or her face. Thus, when exposure control is performed assuming that the subject is a person, an issue may arise where the image of the license plate of the other vehicle becomes so saturated that it can not be read.

In this regard, in the present embodiment, the camera 41 captures images with high sensitivity suitable for a low-illuminance environment, such as at night, since the impact value does not exceed the predefined threshold in cases where a relatively small impact is applied by a person, for example, in a situation of vandalism to and theft from the parked host vehicle V. In contrast, the impact value exceeds the predefined threshold in cases where a relatively large impact is applied by another vehicle, for example, in a situation of the host vehicle colliding with the other vehicle. In such a situation, the lights of the other vehicle are usually on. Thus, an issue may arise where, if the camera 41 captures images with high sensitivity suitable for a low-illuminance environment, such as at night, the image of the license plate of the other vehicle becomes so saturated that it can not be read. In such a case, in the present embodiment, the exposure condition is changed to the exposure condition for a lower sensitivity as compared to the exposure condition for a high sensitivity suitable for a low-illuminance environment, such as at night. That is, in the present embodiment, setting of sensitivity is switched between that for persons and that for other vehicles. This makes it possible to capture good images of any subject in a low-illuminance environment, such as at night.

### Modifications

The present disclosure is not limited to the above embodiment and example. Accordingly, the above embodiment may be changed as appropriate. Representative examples of modifications are described below. In the following description of the modification examples, differences from the above embodiment will mainly be described. In addition, the same number is attached to parts that are identical or equal to each other in the above embodiment and the modification examples. Therefore, in the following description of the modification examples, the description in the above embodiment may be used as appropriate for the constituent elements having the same numbers as in the above embodiment, unless there is any technical contradiction or special additional explanation.

The present disclosure is limited to neither the specific device configuration or application described in the above embodiment. That is, for example, the host vehicle V may be an automobile or a motorcycle. The camera 41 may include a front camera only, front and rear cameras, or a 360-degree camera.

All or part of the control device 42 may be configured with a digital circuit, e.g. an ASIC or FPGA, which is configured to implement the functions or operations described above. ASIC is an abbreviation for Application Specific Integrated Circuit. FPGA is an abbreviation for Field Programmable Gate Array. That is, in the control device 42, the on-board microcomputer portion and the digital circuit portion can coexist.

The program pertaining to the present disclosure that allows the various operations, procedures, or processes described in the above embodiment to be implemented may be downloaded or upgraded via V2X communication. V2X is an abbreviation for Vehicle to X. Alternatively, such a program may be downloaded or upgraded via a terminal device installed in places such as a manufacturing plant, a maintenance plant, or a dealer of the host vehicle V. Such a program may be stored in a memory card, an optical disc, a magnetic disc or the like.

Each of the above-described functional configurations and methods may be realized by a dedicated computer provided by configuring a processor and a memory programmed to execute one or more functions embodied by computer programs. Alternatively, each of the functional configurations and methods described above may be realized by a dedicated computer provided by configuring a processor with one or more dedicated hardware logic circuits. Alternatively, each of the functional configurations and methods described above may be realized by one or more dedicated computers configured by combining a processor and a memory programmed to execute one or more functions with a processor configured by one or more hardware logic circuits. Further, the computer program may also be stored in a computer-readable non-transitory tangible storage medium as an instruction to be executed by a computer. That is, each of the above-described functional configurations and methods can also be represented as a computer program including procedures for implementing each of the above-described functions or methods, or as a non-transitory tangible storage medium storing said program.

The present disclosure is not limited to the specific operations described in the above embodiment. That is, for example, the illuminance acquisition unit 421 may acquire illuminance information corresponding to the brightness of the surroundings of the host vehicle V based on image information from the camera 41, instead of or in addition to the output of the illuminance sensor 32. It is also possible to adjust the gain of the image sensor provided in the camera 41 as the exposure condition. In this case, the exposure control unit 423 and/or the image processing unit 424 may correspond to the components that set the exposure condition in the present disclosure. Furthermore, the routine in FIG. 3 may be configured not only as an exposure control routine when the host vehicle V is parked, that is, when the ignition switch is off, but also as an exposure control routine when the ignition switch is on. In this case, a step of determining the on/off state of the ignition switch and the operating state of the lights of the host vehicle V may be added.

Similar expressions such as “acquisition”, “calculation”, “estimation”, “detection”, and “sensing” may be used interchangeably as long as there is no technical contradiction. In addition, “exceeding the threshold” and “greater than or equal to the threshold” may be used interchangeably as long as there is no technical contradiction. The same applies to “less than the threshold” and “less than or equal to the threshold”.

It is unnecessary to say that the elements constituting the above embodiments are not necessarily essential unless explicitly stated as essential or obviously considered essential in principle. In addition, when a numerical value such as the number, value, amount, or range of a component(s) of any of the above-described embodiments is mentioned, it is not limited to the particular number or value unless expressly stated otherwise or unless it is obviously limited to the particular number or value in principle, etc. When the shape, direction, positional relationship, or the like of a component(s) or the like of any of the embodiments is mentioned, it is not limited to the shape, positional relationship, or the like unless explicitly stated otherwise or unless it is limited to the specific shape, direction, positional relationship, or the like in principle, etc.

The modifications are not limited to the examples described above. For example, all or part of one of a plurality of specific examples may be combined with all or part of another one, as long as there is no technical contradiction. There is no particular limitation on the number of examples that may be combined. Similarly, all or part of one of a plurality of modifications may be combined with all or part of another one, as long as there is no technical contradiction. Furthermore, all or some of the above specific examples may be combined with all or some of the above modifications, as long as there is no technical contradiction.

What is claimed is:

1. An exposure control device for controlling an exposure of a camera mounted to a host vehicle, comprising:
an event information acquisition unit configured to acquire detected information of an event for the host vehicle; and
an exposure control unit configured to set an exposure condition based on the detected information acquired by the event information acquisition unit.

2. The exposure control device according to claim 1, wherein
the event information acquisition unit is configured to acquire, as the detected information, information corresponding to an impact value that is a magnitude of an impact on the host vehicle, and
the exposure control unit is configured to set the exposure condition for a second-type event to be more suitable for a high illuminance than the exposure condition for a first-type event, where the impact value in the second-type event is greater than the impact value in the first-type event.

3. The exposure control device according to claim 2, wherein
the first-type event is application of an impact to the host vehicle by a person, and
the second type event is application of an impact to the host vehicle by another vehicle that is different from the host vehicle.

4. The exposure control device according to claim 1, wherein
the exposure control unit is configured to set the exposure condition when the host vehicle is parked in a low-illuminance environment, based on the detected information of the event acquired by the event information acquisition unit.

5. The exposure control device according to claim 1, wherein
the exposure control device is applied to an on-board imaging apparatus comprising a storage device configured to store images captured by the camera.

6. An exposure control method for controlling an exposure of a camera mounted to a host vehicle, comprising:
acquiring detected information of an event for the host vehicle; and
setting an exposure condition based on the detected information acquired.

7. The exposure control method according to claim 6, wherein
the detected information includes information corresponding to an impact value, which is a magnitude of an impact on the host vehicle, and
setting the exposure condition includes setting the exposure condition for a second-type event to be more suitable for a high illuminance than the exposure condition for a first-type event, where the impact value in the second-type event is greater than the impact value in the first-type event.

8. The exposure control method according to claim 7, wherein
the first-type event is application of an impact to the host vehicle by a person, and
the second type event is application of an impact to the host vehicle by another vehicle that is different from the host vehicle.

9. The exposure control method according to claim 6, wherein
setting the exposure condition includes setting the exposure condition when the host vehicle is parked in a low-illuminance environment, based on the detected information acquired.

10. The exposure control method according to claim 6, wherein
the exposure control method is applied to an on-board imaging apparatus comprising a storage device configured to store images captured by the camera.

11. A computer program product for controlling an exposure of a camera mounted to a host vehicle, the computer program product being embodied in a non-transitory computer readable storage medium and comprising computer instructions for:
acquiring detected information of an event for the host vehicle; and
setting an exposure condition based on the detected information acquired.

12. The computer program product according to claim 11, wherein
the detected information includes information corresponding to an impact value, which is a magnitude of an impact on the host vehicle, and
the computer instructions for setting the exposure condition include computer instructions for setting the exposure condition for a second-type event to be more suitable for a high illuminance than the exposure condition for a first-type event, where the impact value in the second-type event is greater than the impact value in the first-type event.

13. The computer program product according to claim 12, wherein
the first-type event is application of an impact to the host vehicle by a person, and
the second type event is application of an impact to the host vehicle by another vehicle that is different from the host vehicle.

14. The computer program product according to claim 11, wherein
the computer instructions for setting the exposure condition include computer instructions for setting the exposure condition when the host vehicle is parked in a low-illuminance environment, based on the detected information acquired.

15. The computer program product according to claim 11, wherein
the computer program product is applied to an on-board imaging apparatus comprising a storage device configured to store images captured by the camera.
